(19) United States
(12) Patent Application Publication
(10) Pub. No.: US 2025/0309354 A1
(43) Pub. Date: Oct. 2, 2025

(54) ELECTROLYTE COMPRISING AROMATIC COMPOUND WITH NON-FLUORINE HALOGEN SUBSTITUTE AND BATTERIES COMPRISING SAME

(71) Applicant: Factorial Inc., Woburn, MA (US)

(72) Inventors: Zhangxing Shi, Winchester, MA (US); Yiqing Huang, Lexington, MA (US); Elyce An Mei Milligan, Cambridge, MA (US)

(21) Appl. No.: 19/089,208

(22) Filed: Mar. 25, 2025

Related U.S. Application Data
(60) Provisional application No. 63/571,565, filed on Mar. 29, 2024.

(51) Int. Cl. H01M 10/0569; H01M 10/42

(52) U.S. Cl. CPC H01M 10/0569; H01M 10/4235; H01M 2300/0034; H01M 2300/0037

(57) ABSTRACT

Disclosed is a nonaqueous electrolyte comprising a lithium salt and a solvent comprising an aromatic compound with a high boiling point, wherein the aromatic compound comprises a non-fluorine halogen substitute. In some embodiments, the aromatic compound comprises both a fluorine substitute and a non-fluorine halogen substitute. In some embodiments, the solvent further comprises a second compound miscible with the aromatic compound. In one embodiment, the high boiling point is 110° C. or above. The nonaqueous electrolyte and an electrochemical device comprising the same exhibit an improved thermal stability, safety and flame-resistance.

### CROSS-REFERENCE

The present application claims the benefit of U.S. Ser. No. 63/571,565, filed Mar. 30, 2024, the entire content of which is incorporated herein by reference into this application.

### FIELD

The present disclosure relates to a nonaqueous electrolyte with improved thermal stability, flammability and safety for batteries such as lithium metal batteries.

### BACKGROUND

Fluorinated aromatic compounds such as fluorobenzene and difluorobenzene are widely used as solvents or additives in electrolytes due to their electrochemical stability, good ion transportation properties and good cycling performance as a result of formation of LiF-rich solid-electrolyte interface (SEI). However, conventional fluorinated aromatic compounds such as fluorobenzene (FBn) and 1,2-difluorobenzene (dFBn) have a low boiling point (bp) of 85° C. and 92° C., respectively. This may lead to a less desirable safety profile, for example, leaking and venting of electrolyte components, thermal runaway, explosion and/or fire, especially when the electrolyte in a battery experiences a high temperature due to self-heating or external heating. The safety risks will be even higher if the battery comprises a Li metal anode. Thus, there remains a need for electrolytes with improved battery safety.

### SUMMARY

The present disclosure provides a nonaqueous electrolyte comprising a lithium salt and a solvent comprising an aromatic compound with a high boiling point, wherein the aromatic compound comprises a halogen substitute which is not fluorine. In some embodiments, the aromatic compound comprises a non-fluorine halogen substitute selected from the group consisting of Cl, Br, I, and CN (pseudohalogen). In some embodiments, the aromatic compound further comprises fluorine (F) as a substitute.

In some embodiments, the aromatic compound is a non-ionic chemical, i.e., free of ionic structure. In some embodiments, the aromatic compound has a boiling point of at least 110° C. In some embodiments, the solvent further comprises a second compound miscible with the aromatic compound. In one aspect, also disclosed is an electrochemical device, such as a lithium metal battery, comprising the nonaqueous electrolyte. In one embodiment, the battery exhibits an improved safety profile. Methods for preparing the nonaqueous electrolyte and the lithium metal battery are also disclosed.

### BRIEF DESCRIPTION OF THE FIGURES

Non-limiting embodiments of the present disclosure will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure.

FIG. 1 shows the cycling performance of Li/Cu cell comprising Li metal as anode, microporous membrane as separator, Cu foil as cathode, and an electrolyte according to one embodiment of the present disclosure.

FIG. 2 shows the specific capacities at various charge rates (up to 7.5 mA/cm²) of a coin cell comprising Li metal as anode, NMC811 composite electrode as cathode, microporous membrane as separator, and an electrolyte according to one embodiment of the present disclosure.

FIG. 3 shows the cycling performance of a pouch cell comprising comparative example 1 and example 1 as electrolyte in view of specific capacity according to some embodiments of the present disclosure.

FIG. 4 shows the cycling performance of a pouch cell comprising comparative example 1 and example 1 as electrolyte in view of coulombic efficiency (CE) according to some embodiments of the present disclosure.

FIG. 5 shows the differential scanning calorimetry (DSC) measurement of electrolytes according to some embodiments of the present disclosure.

FIG. 6 shows a stacked structure of an electrochemical device according to one embodiment of the present disclosure.

### DETAILED DESCRIPTION

Disclosed is a nonaqueous electrolyte comprising an electrolyte salt (e.g., lithium salt) and a solvent comprising an aromatic compound having a non-fluorine halogen substitute and with a high boiling temperature. In some embodiments, the non-fluorine halogen substitute is at least one selected from the group consisting of Cl, Br, I, and CN (pseudohalogen). In some embodiments, the solvent has a boiling point of at least 110° C. In some embodiments, the nonaqueous electrolyte and an electrochemical device comprising the same exhibit an improved thermal stability and safety, for example having suitable values for one or more of the following: ionic conductivity, average coulombic efficiency, and/or EUCAR (European Council for Automotive Research) hazard level after a hot box test.

The nonaqueous electrolytes disclosed herein include a non-fluorine halogen substitute. As used herein, “halogen” refers to elements in group 17 of the periodic table such as fluorine (F), chlorine (Cl), bromine (Br), and Iodine (I) as well as pseudohalogens such as cyano (CN). As used herein, “pseudohalogens” are polyatomic analogues of halogens with chemistry resembling halogens and allow them to substitute for halogen in a chemical compound. In some embodiments, the nonaqueous electrolyte includes a non-fluorine halogen substitute including, but not limited to, Cl, Br, I, or CN.

In some embodiments, the aromatic compound comprises an aryl or heteroaryl ring. An aryl ring refers to a monocyclic or polycyclic (e.g., bicyclic or tricyclic) 4n+2 aromatic ring system (e.g., having 6, 10, or 14 π electrons shared in a cyclic array) having 6-14 ring carbon atoms and zero heteroatoms provided in the aromatic ring system.

A heteroaryl ring is a 5- to 14-membered monocyclic or polycyclic 4n+2 aromatic ring system (e.g., having 6, 10, or 14 π electrons shared in a cyclic array) having ring carbon atoms and 1-8 ring heteroatoms provided in the aromatic ring system, wherein each heteroatom is independently selected from nitrogen, oxygen and sulfur.

In some embodiments, the non-fluorine halogen is directly attached to the aryl ring or the heteroaryl ring. In some embodiments, the non-fluorine halogen is attached to a side chain on an aryl or heteroaryl ring.

In some embodiments, the aromatic compound includes a non-fluorine halogen substitute only. In some embodiments, the aromatic compound includes a fluorine substitute and a non-fluorine halogen substitute. In some embodiments, the aromatic compound includes at least one selected from the group consisting of chlorobenzene, 1-chloro-2-fluorobenzene, 1-chloro-3-fluorobenzene, 1-chloro-4-fluorobenzene, 1-chloro-2,4-difluorobenzene, bromobenzene, 1-bromo-2-fluorobenzene, 1-bromo-3-fluorobenzene, 1-bromo-4-fluorobenzene, 1-bromo-2,4-difluorobenzene, iodobenzene, 1-iodo-2-fluorobenzene, 1-iodo-3-fluorobenzene, 1-iodo-4-fluorobenzene, 1-iodo-2,4-difluorobenzene, and mixtures thereof.

In some embodiments, the aromatic compound is not an inorganic or organic salt or an ionic liquid. In some embodiments, the organic solvent does not have an ionic structure. In some embodiments, the nonaqueous electrolyte is substantially free of water.

In some embodiments, the solvent is a high boiling point solvent with a boiling point of at least 110° C., at least 120° C., at least 130° C., at least 140° C., at least 150° C., at least 160° C., at least 170° C. or at least 180° C. The boiling point is measured at 1 atm (i.e., 760 mm Hg) unless otherwise specified.

In some embodiments, the nonaqueous electrolyte comprises the solvent with a concentration in a range from 10 wt % to 95 wt %, from 10 wt % to 90 wt %, from 10 wt % to 85 wt %, from 10 wt % to 80 wt %, from 10 wt % to 75 wt %, from 10 wt % to 70 wt %, from 10 wt % to 65 wt %, from 10 wt % to 60 wt %, from 10 wt % to 55 wt %, from 10 wt % to 50 wt %, from 10 wt % to 45 wt %, from 10 wt % to 40 wt %, from 10 wt % to 35 wt %, from 10 wt % to 30 wt %, from 10 wt % to 25 wt %, from 10 wt % to 20 wt %, from 15 wt % to 95 wt %, from 15 wt % to 90 wt %, from 15 wt % to 85 wt %, from 15 wt % to 80 wt %, from 15 wt % to 75 wt %, from 15 wt % to 70 wt %, from 15 wt % to 65 wt %, from 15 wt % to 60 wt %, from 15 wt % to 55 wt %, from 15 wt % to 50 wt %, from 15 wt % to 45 wt %, from 15 wt % to 40 wt %, from 15 wt % to 35 wt %, from 15 wt % to 30 wt %, from 15 wt % to 25 wt %, from 15 wt % to 20 wt %, from 20 wt % to 95 wt %, from 20 wt % to 90 wt %, from 20 wt % to 85 wt %, from 20 wt % to 80 wt %, from 20 wt % to 75 wt %, from 20 wt % to 70 wt %, from 20 wt % to 65 wt %, from 20 wt % to 60 wt %, from 20 wt % to 55 wt %, from 20 wt % to 50 wt %, from 20 wt % to 45 wt %, from 20 wt % to 40 wt %, from 20 wt % to 35 wt %, from 20 wt % to 30 wt %, from 25 wt % to 95 wt %, from 25 wt % to 90 wt %, from 25 wt % to 85 wt %, from 25 wt % to 80 wt %, from 25 wt % to 75 wt %, from 25 wt % to 70 wt %, from 25 wt % to 65 wt %, from 25 wt % to 60 wt %, from 25 wt % to 55 wt %, from 25 wt % to 50 wt %, from 25 wt % to 45 wt %, from 25 wt % to 40 wt %, from 25 wt % to 35 wt %, from 25 wt % to 30 wt %, from 25 wt % to 95 wt %, from 25 wt % to 90 wt %, from 25 wt % to 85 wt %, from 25 wt % to 80 wt %, from 25 wt % to 75 wt %, from 25 wt % to 70 wt %, from 25 wt % to 65 wt %, from 25 wt % to 60 wt %, from 25 wt % to 55 wt %, from 25 wt % to 50 wt %, from 25 wt % to 45 wt %, from 25 wt % to 40 wt %, from 25 wt % to 35 wt %, from 25 wt % to 30 wt %, from 30 wt % to 95 wt %, from 30 wt % to 90 wt %, from 30 wt % to 85 wt %, from 30 wt % to 80 wt %, from 30 wt % to 75 wt %, from 30 wt % to 70 wt %, from 30 wt % to 65 wt %, from 30 wt % to 60 wt %, from 30 wt % to 55 wt %, from 30 wt % to 50 wt %, from 30 wt % to 45 wt %, from 30 wt % to 40 wt %, from 30 wt % to 35 wt %, or any and all ranges and subranges therebetween.

In some embodiments, the solvent of the nonaqueous electrolyte further includes a second compound. In some embodiments, the second compound is miscible with the aromatic compound. In some embodiments, the aromatic compound and the second compound form a homogeneous solution to ensure and/or enhance the solubility of the electrolyte salt.

In some embodiments, the second compound has a high boiling point (greater than or equal to 110° C.). In some embodiments, the second solvent is non-fluorinated ether, fluorinated ether, ionic liquid, ester, phosphate, sulfone, or mixtures thereof. In some embodiments, the nonaqueous electrolyte is substantially free of carbonate solvent.

In some embodiments, the fluorinated ether is selected from the group consisting of bis(2,2,2-trifluoroethoxy)methane (BTFM), 1H,1H,5H-octafluoropentyl 1,1,2,2-tetrafluoroethyl ether (OTE), and tris(2,2,2-trifluoroethyl)orthoformate (TFEO).

In some embodiments, the fluorinated ether has a weight percentage in a range from 1 wt % to 40 wt % in the nonaqueous electrolyte.

In some embodiments, the nonaqueous electrolyte further includes an ionic liquid as the second compound. In some embodiments, the ionic liquid is miscible with the aromatic compound. In some embodiments, the ionic liquid is an imidazolium ionic liquid, a cyclic quaternary ammonium ionic liquid, a phosphonium ionic liquid, a sulfonium ionic liquid, or mixtures thereof.

In some embodiments, the ionic liquid has a formula of

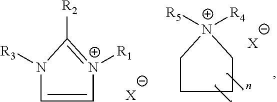

wherein R₁, R₂, R₃ are independently selected from the group consisting of hydrogen, C₁₋₁₈ alkyl, C₁₋₁₈ haloalkyl, C₁₋₁₈ hydroxyalkyl, C₁₋₁₈ aminoalkyl, C₂₋₁₈ alkenyl, C₂₋₁₈ alkynyl, and C₁₋₁₈ aryl, n is an integer having a value in a range from 0 to 6, R₄ and R₅ are independently selected from the group consisting of C₁₋₁₈ alkyl, C₁₋₁₈ haloalkyl, C₁₋₁₈ hydroxyalkyl, C₁₋₁₈ aminoalkyl, C₂₋₁₈ alkenyl, C₂₋₁₈ alkynyl, and C₆₋₁₈ aryl, and X⁻ is an anion. Nonlimiting specific C₁₋₁₈ alkyls include methyl (—CH₃), ethyl (—CH₂CH₃), i-propyl (—CH(CH₃)₂), n-propyl (—CH₂CH₂CH₃), n-butyl (—CH₂[CH₂]₂CH₃), i-butyl (—CH₂CH(CH₃)₂), n-pentyl (—CH₂[CH₂]₃CH₃), n-hexyl (—CH₂[CH₂]₄CH₃), n-heptyl (—CH₂[CH₂]₅CH₃), n-octyl (—CH₂[CH₂]₆CH₃), n-nonyl (—CH₂[CH₂]₇CH₃), n-decyl (—CH₂[CH₂]₈CH₃), n-undecyl (—CH₂[CH₂]₉CH₃), n-dodecyl (—CH₂[CH₂]₁₀CH₃), n-tridecyl (—CH₂[CH₂]₁₁CH₃), n-tetradecyl (—CH₂[CH₂]₁₂CH₃), n-hexadecyl (—CH₂[CH₂]₁₄CH₃), n-octadecyl (—CH₂[CH₂]₁₆CH₃), and any combination thereof.

In some embodiments, R₁, R₂, R₃, R₄, and R₅ are independently selected from C₁₋₄ alkyl-O—C₁₋₈ alkyl, —[O—C₁₋₄ alkylene]m-C₁₋₈ alkyl, where m is an integer having a value in a range from 1 to 6.

In some embodiments, the anion X⁻ is selected from the group consisting of bis(fluorosulfonyl)imide (FSI⁻), bis(trifluoromethanesulfonyl)imide (TFSI⁻), hexafluorophosphate (PF₆⁻), tetrafluoroborate (BF₄⁻), bis(oxalate)borate (BOB⁻), difluoro(oxalato)borate (DFOB⁻), trifluoromethanesulfonate (TfO⁻), nitrate (NO₃⁻), dicyanamide (DCA⁻), fluoride (F⁻), chloride (Cl⁻), bromide (Br⁻), and mixtures thereof.

In some embodiments, the ionic liquid is selected from the group consisting of 1-ethyl-3-methylimidazolium bis(fluorosulfonyl) imide (EmimFSI), 1-butyl-3-methylimidazolium bis(fluorosulfonyl) imide (BmimFSI), 1-hexyl-3-methylimidazoliumbis(fluorosulfonyl) imide (HmimFSI), 1-vinyl-3-methylimidazolium bis(fluorosulfonyl) imide (VmimFSI), 1-ethyl-3-methylimidazolium bis(trifluoromethanesulfonyl) imide (EmimTFSI), 1-butyl-3-methylimidazolium bis(trifluoromethanesulfonyl) imide (BmimTFSI), 1-hexyl-3-methylimidazolium bis(trifluoromethanesulfonyl) imide (HmimTFSI), 1-vinyl-3-methylimidazolium bis(trifluoromethanesulfonyl) imide (VmimTFSI), N-propyl-N-methylpyrrolidinium bis(fluorosulfonyl)imide (PYR13FSI), N-propyl-N-methylpyrrolidinium bis(trifluoromethanesulfonyl)imide (PYR13TFSI) 1-butyl-1-methylpyrrolidinium bis(fluorosulfonyl)imide (PYR14FSI), 1-butyl-1-methylpyrrolidinium bis(oxalate)borate (PYR14BOB), 1-butyl-1-methylpyrrolidinium bis(trifluoromethanesulfonyl)imide (PYR14TFSI), 1-butyl-1-methylpyrrolidinium dicyanamide (PYR14DCA), 1-butyl-1-methylpyrrolidinium trifluoromethanesulfonate (PYR14TfO), 1-methyl-1-(2-methoxyethyl)pyrrolidinium bis(fluorosulfonyl)imide (PYOFSI), 1-methyl-1-pentylpyrrolidinium bis(trifluoromethanesulfonyl)imide (PYR15TFSI), 1-methyl-1-octylpyrrolidinium bis(trifluoromethanesulfonyl)imide (PYR18TFSI), N-propyl-N-methylpiperidinium bis(fluorosulfonyl)imide, N-propyl-N-methylpiperidinium bis(trifluoromethanesulfonyl)imide, 1-butyl-1-methylpiperidinium bis(fluorosulfonyl)imide, 1-butyl-1-methylpiperidinium bis(oxalate)borate, 1-butyl-1-methylpiperidinium bis(trifluoromethanesulfonyl)imide, 1-butyl-1-methylpiperidinium dicyanamide, 1-butyl-1-methylpiperidinium trifluoromethanesulfonate, 1-methyl-1-(2-methoxyethyl)piperidinium bis(fluorosulfonyl)imide, 1-methyl-1-pentylpiperidinium bis(trifluoromethanesulfonyl)imide, 1-methyl-1-octylpiperidinium bis(trifluoromethanesulfonyl)imide, N-propyl-N-methylazepanium bis(fluorosulfonyl)imide, N-propyl-N-methylazepanium bis(trifluoromethanesulfonyl)imide, 1-butyl-1-methylazepanium bis(fluorosulfonyl)imide, 1-butyl-1-methylazepanium bis(oxalate)borate, 1-butyl-1-methylazepanium bis(trifluoromethanesulfonyl)imide, 1-butyl-1-methyl azepanium dicyanamide, 1-butyl-1-methylazepanium trifluoromethanesulfonate, 1-methyl-1-(2-methoxyethyl)azepanium bis(fluorosulfonyl)imide, 1-methyl-1-pentylazepanium bis(trifluoromethanesulfonyl)imide, 1-methyl-1-octylazepanium bis(trifluoromethanesulfonyl)imide and mixtures thereof.

In some embodiments, the nonaqueous electrolyte includes an ionic liquid with a weight percentage in a range from 10 wt % to 80 wt %, from 10 wt % to 70 wt %, from 10 wt % to 60 wt %, from 10 wt % to 50 wt %, from 10 wt % to 45 wt %, from 10 wt % to 40 wt %, from 10 wt % to 35 wt %, from 10 wt % to 30 wt %, from 20 wt % to 80 wt %, from 20 wt % to 70 wt %, from 20 wt % to 60 wt %, from 20 wt % to 50 wt %, from 20 wt % to 45 wt %, from 20 wt % to 40 wt %, from 20 wt % to 35 wt %, from 20 wt % to 30 wt %, from 30 wt % to 80 wt %, from 30 wt % to 70 wt %, from 30 wt % to 60 wt %, from 30 wt % to 50 wt %, from 30 wt % to 45 wt %, from 30 wt % to 40 wt %, from 35 wt % to 80 wt %, from 35 wt % to 70 wt %, from 35 wt % to 60 wt %, from 35 wt % to 50 wt %, from 35 wt % to 45 wt %, from 35 wt % to 40 wt %, from 40 wt % to 80 wt %, from 40 wt % to 70 wt %, from 40 wt % to 60 wt %, from 40 wt % to 50 wt %, or any and all ranges and subranges therebetween.

In some embodiments, the lithium salt may include one or more lithium salts. In one embodiment, the lithium salts are selected from the group consisting of lithium bis(fluorosulfonyl) imide (LiFSI), lithium perchlorate (LiClO₄), lithium hexafluorophosphate (LiPF₆), lithium borofluoride (LiBF₄), lithium hexafluoroarsenide (LiAsF₆), lithium trifluoromethanesulfonate (LiCF₃SO₃), lithium bis(trifluoromethanesulfonyl)imide (LiN(CF₃SO₂)₂, LiTFSI), lithium bis(oxalato)borate (LiBOB), lithium nitrate (LiNO₃), lithium fluoroalkylphosphates (Li[PFₓ(C_{y}F_{2y+1-z}H_{z})₆₋ₓ]) (1≤x≤5, 1≤y≤8, and 0≤z≤2y−1), lithium bis(perfluoroethanesulfonyl)imide (LiBETI), lithium difluoro(oxalato)borate (LiDFOB), lithium fluorophosphate (Li₂PO₃F), lithium difluoro(bisoxalato)phosphate (LiC₄PO₈F₂), lithium tetrafluoro oxalato phosphate (LiC₂PO₄F₄), lithium difluorophosphate (LiDFP), LiC(CF₃SO₂)₃, lithium acetate, lithium trifluoromethyl acetate, lithium oxalate, and mixtures thereof.

In some embodiments, the nonaqueous electrolyte includes a lithium salt with a concentration in a range from 10 wt % to 60 wt %, from 10 wt % to 55 wt %, from 10 wt % to 50 wt %, from 10 wt % to 45 wt %, from 10 wt % to 40 wt %, from 10 wt % to 35 wt %, from 10 wt % to 30 wt %, from 10 wt % to 25 wt %, from 10 wt % to 20 wt %, from 12.5 wt % to 60 wt %, from 12.5 wt % to 55 wt %, from 12.5 wt % to 50 wt %, from 12.5 wt % to 45 wt %, from 12.5 wt % to 40 wt %, from 12.5 wt % to 35 wt %, from 12.5 wt % to 30 wt %, from 12.5 wt % to 25 wt %, from 12.5 wt % to 20 wt %, from 15 wt % to 60 wt %, from 15 wt % to 55 wt %, from 15 wt % to 50 wt %, from 15 wt % to 45 wt %, from 15 wt % to 40 wt %, from 15 wt % to 35 wt %, from 15 wt % to 30 wt %, from 15 wt % to 25 wt %, from 15 wt % to 20 wt %, from 17.5 wt % to 60 wt %, from 17.5 wt % to 55 wt %, from 17.5 wt % to 50 wt %, from 17.5 wt % to 45 wt %, from 17.5 wt % to 40 wt %, from 17.5 wt % to 35 wt %, from 17.5 wt % to 30 wt %, from 17.5 wt % to 25 wt %, from 17.5 wt % to 20 wt %, from 20 wt % to 60 wt %, from 20 wt % to 55 wt %, from 20 wt % to 50 wt %, from 20 wt % to 45 wt %, from 20 wt % to 40 wt %, from 20 wt % to 35 wt %, from 20 wt % to 30 wt %, from 20 wt % to 25 wt %, or any and all ranges and subranges therebetween.

In some embodiments, the nonaqueous electrolyte further includes a polymer to improve the thermal stability and/or safety. In some embodiments, the polymer is added into a mixture containing a lithium salt, and a solvent comprising an aromatic compound including a non-fluorine halogen substitute. In some embodiments, the aromatic compound is an ether comprising a non-fluorine halogen substitute.

In some embodiments, the nonaqueous electrolyte includes a polymer with a concentration in a range from 0.01 wt % to 20 wt %, from 0.01 wt % to 17.5 wt %, from 0.01 wt % to 15 wt %, from 0.01 wt % to 12.5 wt %, from 0.01 wt % to 10 wt %, from 0.01 wt % to 7.5 wt %, from 0.01 wt % to 5.0 wt %, from 0.01 wt % to 2.5 wt %, from 0.01 wt % to 2.0 wt %, from 0.01 wt % to 1.75 wt %, from 0.01 wt % to 1.5 wt %, from 0.01 wt % to 1.25 wt %, from 0.01 wt % to 1.0 wt %, from 0.025 wt % to 20 wt %, from 0.025 wt % to 17.5 wt %, from 0.025 wt % to 15 wt %, from 0.025 wt % to 12.5 wt %, from 0.025 wt % to 10 wt %, from 0.025 wt % to 7.5 wt %, from 0.025 wt % to 5.0 wt %, from 0.025 wt % to 2.5 wt %, from 0.025 wt % to 2.0 wt %, from 0.025 wt % to 1.75 wt %, from 0.025 wt % to 1.5 wt %, from 0.025 wt % to 1.25 wt %, from 0.025 wt % to 1.0 wt %, from 0.05 wt % to 20 wt %, from 0.05 wt % to 17.5 wt %, from 0.05 wt % to 15 wt %, from 0.05 wt % to 12.5 wt %, from 0.05 wt % to 10 wt %, from 0.05 wt % to 7.5 wt %, from 0.05 wt % to 5.0 wt %, from 0.05 wt % to 2.5 wt %, from 0.05 wt % to 2.0 wt %, from 0.05 wt % to 1.75 wt %, from 0.05 wt % to 1.5 wt %, from 0.05 wt % to 1.25 wt %, from 0.05 wt % to 1.0 wt %, from 0.1 wt % to 20 wt %, from 0.1 wt % to 17.5 wt %, from 0.1 wt % to 15 wt %, from 0.1 wt % to 12.5 wt %, from 0.1 wt % to 10 wt %, from 0.1 wt % to 7.5 wt %, from 0.1 wt % to 5.0 wt %, from 0.1 wt % to 2.5 wt %, from 0.1 wt % to 2.0 wt %, from 0.1 wt % to 1.75 wt %, from 0.1 wt % to 1.5 wt %, from 0.1 wt % to 1.25 wt %, from 0.1 wt % to 1.0 wt %, from 0.25 wt % to 20 wt %, from 0.25 wt % to 17.5 wt %, from 0.25 wt % to 15 wt %, from 0.25 wt % to 12.5 wt %, from 0.25 wt % to 10 wt %, from 0.25 wt % to 7.5 wt %, from 0.25 wt % to 5.0 wt %, from 0.25 wt % to 2.5 wt %, from 0.25 wt % to 2.0 wt %, from 0.25 wt % to 1.75 wt %, from 0.25 wt % to 1.5 wt %, from 0.25 wt % to 1.25 wt %, from 0.25 wt % to 1.0 wt %, from 0.5 wt % to 20 wt %, from 0.5 wt % to 17.5 wt %, from 0.5 wt % to 15 wt %, from 0.5 wt % to 12.5 wt %, from 0.5 wt % to 10 wt %, from 0.5 wt % to 7.5 wt %, from 0.5 wt % to 5.0 wt %, from 0.5 wt % to 2.5 wt %, from 0.5 wt % to 2.0 wt %, from 0.5 wt % to 1.75 wt %, from 0.5 wt % to 1.5 wt %, from 0.5 wt % to 1.25 wt %, from 0.5 wt % to 1.0 wt %, or any and all ranges and subranges therebetween.

In some embodiments, the polymer is in situ polymerized after a polymerizable monomer and initiator is mixed with a lithium salt, and a solvent comprising an aromatic compound having a non-fluorine halogen substitute. When a nonaqueous electrolyte comprises a polymer, the electrolyte is referred to as polymer electrolyte.

In some embodiments, the polymer electrolyte is prepared by an in situ polymerization in the presence of an initiator such as azobisisobutyronitrile (AIBN), ammonium persulfate (APS), potassium persulfate (PPS), sodium persulfate (SPS), and lithium persulfate (LPS). In some embodiments, the polymer electrolyte is prepared by an in situ polymerization in the presence of an initiator that does not generate gas during the polymerization. Such a non-gas generating initiator is an initiator that does not have any groups leading to gas formation during the polymerization.

In some embodiments, the initiator is a persulfate. In some embodiments, a persulfate initiator comprises an anion of SO₅²⁻, S₂O₈²⁻, or both. In some embodiments, non-limiting specific persulfate initiators include ammonium persulfate (APS), potassium persulfate (PPS), sodium persulfate (SPS), lithium persulfate (LPS) and any combination thereof. In some embodiments, the nonaqueous electrolyte composition does not include gas generating initiators, such as azobisisobutyronitrile (AIBN) and benzoyl peroxide (BPO).

In some embodiments, the mixture prior to in situ polymerization contains an initiator in an amount from 0.001 wt % to 10 wt %. In some embodiments, the mixture contains an initiator in an amount from 0.002 wt % to 10 wt %, from 0.005 wt % to 10 wt %, from 0.01 wt % to 10 wt %, from 0.02 wt % to 10 wt %, from 0.05 wt % to 10 wt %, from 0.1 wt % to 10 wt %, from 0.2 wt % to 10 wt %, from 0.5 wt % to 10 wt %, from 1.0 wt % to 10 wt %, from 2.0 wt % to 10 wt % or any and all ranges and subranges therebetween.

In some embodiments, the monomer contains one or more polymerizable groups. In some embodiments, non-limiting specific polymerizable groups include vinyl (—CH═CH₂), substituted vinyl (—CR₁═CR₂R₃) and a combination thereof, wherein R₁, R₂ and R₃ are independently hydrogen, halogen, —CN, —NO₂, C₁₋₆ alkyl, C₁₋₆haloalkyl, C₁₋₆ hydroxyalkyl, C₁₋₆ aminoalkyl, C₂₋₆ alkenyl, C₂₋₆ alkynyl, C₆₋₁₄ aryl or any combination thereof. Non-limiting specific monomers include 2,2,3,3-tetrafluorobutane-1,4-diacrylate, 2,2,3,3,4,4,5,5-octafluorohexane-1,6-diyl diacrylate, 2,2,3,3,4,4,5,5-octafluorohexane-1,6-diyl bis(2-methylacrylate), poly(ethylene glycol) diacrylate (Mn=500-5000), triethylene glycol dimethacrylate (TEGDMA), diurethane dimethacrylate, and any combination thereof.

In some embodiments, non-limiting monomers are one or more selected from tetraallyl silane (TAS), 2,4,6,8-tetramethyl-2,4,6,8-tetravinylcyclotetrasiloxane, triethoxyvinylsilane, allyltriethoxysilane, pentaerythritol tetraacrylate (PETA), pentaerythritol tetramethacrylate (PETMA), tris[2-(acryloyloxy)ethyl]isocyanurate (TAEI), di(trimethylolpropane) tetraacrylate (Di-TMPTA), trimethylolpropane propoxylate triacrylate, trimethylolpropane trimethacrylate, pentaerythritol triacrylate, and dipentaerythritol hexaacrylate.

In some embodiments, the polymer electrolyte is prepared from a mixture containing multiple monomers.

In some embodiments, the monomer is mixed with a lithium salt and a solvent comprising an aromatic compound having a non-fluorine halogen substitute and with a high boiling point to form a mixture. In some embodiments, the mixture contains the monomer with a concentration in a range from 0.01 wt % to 20 wt %, from 0.01 wt % to 17.5 wt %, from 0.01 wt % to 15 wt %, from 0.01 wt % to 12.5 wt %, from 0.01 wt % to 10 wt %, from 0.01 wt % to 7.5 wt %, from 0.01 wt % to 5.0 wt %, from 0.01 wt % to 2.5 wt %, from 0.01 wt % to 2.0 wt %, from 0.01 wt % to 1.75 wt %, from 0.01 wt % to 1.5 wt %, from 0.01 wt % to 1.25 wt %, from 0.01 wt % to 1.0 wt %, from 0.025 wt % to 20 wt %, from 0.025 wt % to 17.5 wt %, from 0.025 wt % to 15 wt %, from 0.025 wt % to 12.5 wt %, from 0.025 wt % to 10 wt %, from 0.025 wt % to 7.5 wt %, from 0.025 wt % to 5.0 wt %, from 0.025 wt % to 2.5 wt %, from 0.025 wt % to 2.0 wt %, from 0.025 wt % to 1.75 wt %, from 0.025 wt % to 1.5 wt %, from 0.025 wt % to 1.25 wt %, from 0.025 wt % to 1.0 wt %, from 0.05 wt % to 20 wt %, from 0.05 wt % to 17.5 wt %, from 0.05 wt % to 15 wt %, from 0.05 wt % to 12.5 wt %, from 0.05 wt % to 10 wt %, from 0.05 wt % to 7.5 wt %, from 0.05 wt % to 5.0 wt %, from 0.05 wt % to 2.5 wt %, from 0.05 wt % to 2.0 wt %, from 0.05 wt % to 1.75 wt %, from 0.05 wt % to 1.5 wt %, from 0.05 wt % to 1.25 wt %, from 0.05 wt % to 1.0 wt %, from 0.1 wt % to 20 wt %, from 0.1 wt % to 17.5 wt %, from 0.1 wt % to 15 wt %, from 0.1 wt % to 12.5 wt %, from 0.1 wt % to 10 wt %, from 0.1 wt % to 7.5 wt %, from 0.1 wt % to 5.0 wt %, from 0.1 wt % to 2.5 wt %, from 0.1 wt % to 2.0 wt %, from 0.1 wt % to 1.75 wt %, from 0.1 wt % to 1.5 wt %, from 0.1 wt % to 1.25 wt %, from 0.1 wt % to 1.0 wt %, from 0.25 wt % to 20 wt %, from 0.25 wt % to 17.5 wt %, from 0.25 wt % to 15 wt %, from 0.25 wt % to 12.5 wt %, from 0.25 wt % to 10 wt %, from 0.25 wt % to 7.5 wt %, from 0.25 wt % to 5.0 wt %, from 0.25 wt % to 2.5 wt %, from 0.25 wt % to 2.0 wt %, from 0.25 wt % to 1.75 wt %, from 0.25 wt % to 1.5 wt %, from 0.25 wt % to 1.25 wt %, from 0.25 wt % to 1.0 wt %, from 0.5 wt % to 20 wt %, from 0.5 wt % to 17.5 wt %, from 0.5 wt % to 15 wt %, from 0.5 wt % to 12.5 wt %, from 0.5 wt % to 10 wt %, from 0.5 wt % to 7.5 wt %, from 0.5 wt % to 5.0 wt %, from 0.5 wt % to 2.5 wt %, from 0.5 wt % to 2.0 wt %, from 0.5 wt % to 1.75 wt %, from 0.5 wt % to 1.5 wt %, from 0.5 wt % to 1.25 wt %, from 0.5 wt % to 1.0 wt %, or any and all ranges and subranges therebetween.

In some embodiments, the nonaqueous electrolyte comprises 25 wt % to 50 wt % lithium salt, and 50 wt % to 75 wt % solvent in the absence of ionic liquid. In some embodiments, the solvent is a mixture comprising at least one solvent with a high boiling point (110° C. or higher). In some embodiments, the nonaqueous electrolyte comprises 10 wt % to 45 wt % lithium salt, 10 wt % to 55 wt % solvent, and 20 wt % to 60 wt % ionic liquid. In some embodiments, the lithium salt and the ionic liquid have the same anion to minimize ion exchange.

In some embodiments, the nonaqueous electrolyte as disclosed herein exhibits a good ionic conductivity. In some embodiments, the electrolyte as disclosed herein exhibits an ionic conductivity of 1.0 mS/cm or higher, 2.0 mS/cm or higher, 2.5 mS/cm or higher, 3.0 mS/cm or higher, 3.5 mS/cm or higher, 4.0 mS/cm or higher, 4.5 mS/cm or higher, 5.0 mS/cm or higher, 5.5 mS/cm or higher, 6.0 mS/cm or higher, 6.5 mS/cm or higher, or 7.0 mS/cm or higher at 25° C.

In some embodiments, the nonaqueous electrolyte as disclosed herein exhibits an improved thermal stability in comparison to the one comprising a solvent with a boiling point of less than 110° C. In one embodiment, the nonaqueous electrolyte as disclosed herein does not exhibit any exothermic or endothermic peak in a differential scanning calorimetry (DSC) curve in a range from 25° C. to 110° C. (excluding the peak at the beginning of DSC scanning caused by the DSC system coming to equilibrium). Whether a reversible peak is exothermic or endothermic depends on the scanning direction.

In some embodiments, the nonaqueous electrolyte does not include any solvent that has a boiling point less than 100° C., less than 110° C., or less than 120° C. to ensure and/or further improve the thermal stability, flame resistance and safety.

In one aspect, the present disclosure provides an electrochemical device such as lithium metal battery comprising the nonaqueous electrolyte disclosed herein. In some embodiments, a battery comprises a cathode layer (1), an anode layer (2), electrolyte (3) and a separator (4) as shown in FIG. 6. In some embodiments, the cathode layer (1) comprises a cathode current collector (10) and a cathode active material layer (11). In some embodiments, the anode layer (2) comprises an anode current collector (20) and an anode active material layer (21). In some embodiments, the anode active material layer (21) is formed after the initial charge cycle. The electrolyte (3) is located between the separator (4) and either electrode, i.e., either the cathode layer (1) or the anode layer (2). In some embodiments, the electrolyte (3) and the separator (4) are mixed together to form one layer, i.e., electrolyte is present inside the separator. In some embodiments, the anode active material layer (21) comprises lithium metal or lithium alloy. In some embodiments, the electrolyte of the present disclosure is chemically stable in the presence of lithium metal or alloy in the anode, i.e., components of the electrolyte do not chemically react with lithium metal or alloy under a normal operating condition.

In some embodiments, an electrochemical device comprising the nonaqueous electrolyte exhibits an improved cycling performance. In some embodiments, the electrochemical device comprising an electrolyte disclosed herein has an average Coulombic efficiency (CE) of no less 98.00%, no less than 98.25%, no less than 98.50%, no less than 98.75%, no less than 99.00%, no less than 99.10%, no less than 99.15%, no less than 99.20%, no less than 99.25%, no less than 99.30%, or no less than 99.35%.

In some embodiments, an electrochemical device comprises a nonaqueous electrolyte with a good ionic conductivity (1.0 mS/cm or higher, 2.0 mS/cm or higher, 2.5 mS/cm or higher, 3.0 mS/cm or higher, 3.5 mS/cm or higher, 4.0 mS/cm or higher, 4.5 mS/cm or higher, 5.0 mS/cm or higher, 5.5 mS/cm or higher, 6.0 mS/cm or higher, 6.5 mS/cm or higher, or 7.0 mS/cm or higher at 25° C.) and simultaneously exhibits a desirable average CE, which can be no less 98.00%, no less than 98.25%, no less than 98.50%, no less than 98.75%, no less than 99.00%, no less than 99.10%, no less than 99.15%, no less than 99.20%, no less than 99.25%, no less than 99.30%, or no less than 99.35%.

In one embodiment, an electrochemical device comprising the nonaqueous electrolyte as disclosed herein exhibits an improved thermal stability and safety. Out of many ways, battery safety can be characterized by a hot box test. In general, a fully charged electrochemical device (100% state-of-charge) is placed into an oven in which the temperature of the electrochemical device such as a cell is heated from room temperature (25° C.) to a desired high temperature (such as 190° C.) at a rate of 5° C./minute and with a holding of 10 min at each of the following temperatures: 130° C., 140° C., 150° C., 160° C., 170° C., 180° C., and 190° C.

In some embodiments, after the hot box test, the electrochemical device does not experience electrolyte leakage, weight loss, explosion, and/or has a European Council for Automotive Research (EUCAR) hazard level of 4 or below or 3 or below.

In some embodiments, after the hot box test, the electrochemical device undergoes a weight loss of 40 wt % or less, 45 wt % or less, or less than 50 wt %, based on the total weight of electrolyte in the electrochemical device.

In some embodiments, the electrochemical device passes a hotbox test with a European Council for Automotive Research (EUCAR) hazard level of 4 or below or 3 or below. The EUCAR hazard level is shown in Table 1.

TABLE 1
European Council for Automotive Research Hazard Levels

| Hazard | | |
|---|---|---|
| Level | Description | Classification Criteria |
| 0 | No effect | No effect. No loss of functionality |
| 1 | Passive | No defect; no leakage; no venting; no fire |
| | protection | or flame; no rupture; no explosion; no |
| | activated | exothermic reaction or thermal runaway. |
| | | Cell irreversibly damaged. Repair is needed |
| 2 | Defect/Damage | No leakage; no venting; no fire or flame; |
| | | no rupture; no explosion; no exothermic |
| | | reaction or thermal runaway. Cell |
| | | irreversibly damaged. Repair is needed |
| 3 | Leakage, Δ | No venting; no fire or flame; no rupture; |
| | mass < 50% | no explosion; weight loss < 50% of |
| | | electrolyte weight (electrolyte = |
| | | salt + solvent) |
| 4 | Venting, Δ | No fire or flame; no rupture; no explosion; |
| | mass ≥ 50% | weight loss ≥ 50% of electrolyte weight |
| | | (electrolyte = salt + solvent) |
| 5 | Fire or Flame | No rupture; no explosion (e.g., no flying |
| | | parts) |
| 6 | Rupture | No explosion; but flying parts of the active |
| | | mass |
| 7 | Explosion | Explosion (e.g., disintegration of the cell) |

In some embodiments, the electrochemical device comprising the nonaqueous electrolyte as disclosed herein exhibits a capacity retention of at least 80% after at least 100 cycles at a charge and discharge rate of 0.33 C. In some embodiments, 1 C rate is 3.0 mA/cm¹ current density.

In some embodiments, the electrochemical device exhibits a capacity retention at least 10% higher than an identical electrochemical device comprising a solvent which does not include non-fluorine halogen substitute at a rate of 0.5 C or higher.

In some embodiments, the electrochemical device is a coin cell, a pouch cell, or a prismatic cell.

In another aspect, the present disclosure provides a method for preparing an electrochemical device comprising a nonaqueous electrolyte with a solvent with a boiling point of 110° C. or higher, wherein the solvent comprises an aromatic compound having a non-fluorine halogen substitute. In some embodiments, the aromatic compound is an ether comprising a non-fluorine halogen substitute. In some embodiments, the aromatic compound is not flammable. In some embodiments, all components in the nonaqueous electrolyte including all solvents have a boiling point of 110° C. or higher. In some embodiments, the electrochemical device comprises an anode layer, a separator, and a cathode layer. In some embodiments, the method comprises: mixing lithium salt, ionic liquid, and the solvent into a nonaqueous electrolyte.

In some embodiments, the disclosure provides a method for preparing an electrochemical device comprising an anode layer, a separator, a cathode layer, and an electrolyte as disclosed herein. In one embodiment, the method may comprise:
1) mixing a lithium salt, and a solvent comprising an aromatic compound having a non-fluorine halogen substitute into an electrolyte;
2) placing the anode layer, the separator, and the cathode layer into an assembly;
3) injecting the electrolyte into the assembly, thus forming an electrochemical device comprising the anode layer, the separator, the cathode layer and the electrolyte.

In some embodiments, the solvent has a high boiling point, such as no less than 110° C. In some embodiments, the aromatic compound is an ether comprising a non-fluorine halogen substitute. In some embodiments, the aromatic compound includes a non-fluorine halogen substitute and one or more fluorine as substitute. In some embodiments, the non-fluorine halogen substitute is located either on the aryl or heteroaryl ring or on a side chain attached to the ring, or both. In some embodiments, the non-fluorine halogen substitute is directly attached to the aryl or heteroaryl ring.

In some embodiments, the aromatic compound is at least one selected from the group consisting of chlorobenzene, 1-chloro-2-fluorobenzene, 1-chloro-3-fluorobenzene, 1-chloro-4-fluorobenzene, 1-chloro-2,4-difluorobenzene, bromobenzene, 1-bromo-2-fluorobenzene, 1-bromo-3-fluorobenzene, 1-bromo-4-fluorobenzene, 1-bromo-2,4-difluorobenzene, iodobenzene, 1-iodo-2-fluorobenzene, 1-iodo-3-fluorobenzene, 1-iodo-4-fluorobenzene, 1-iodo-2,4-difluorobenzene, and mixtures thereof

The disclosure will be better understood by reference to the Experimental Details which follow, but those skilled in the art will readily appreciate that the specific experiments detailed are only illustrative, and are not meant to limit the disclosure as described herein, as numerous variations and modifications of these exemplary embodiments are possible without undue experimentation. All such variations and modifications are within the scope of the teachings of this disclosure. It will be appreciated that the foregoing description and following examples, no matter how detailed they may appear in text, the disclosure may be practiced in many ways, and the disclosure should be construed in accordance with the appended claims and equivalents thereof.

### Example

Li stripping/plating coulombic efficiency (CE) is a critical parameter for the evaluation of electrolyte stability on Li metal anode. The Li stripping/plating CE was obtained by stripping/plating cycles in Li/Cu cells comprising Li metal as anode, Cu foil as cathode, microporous membrane as a separator, and an electrolyte with a composition in Table 2 prepared by mixing LiFSI as a lithium salt, and a solvent comprising 1-chloro-2-fluorobenzene (CFBn) (bp of 138° C.) as an aromatic compound containing a non-fluorine substitute, and 1-ethyl-3-methylimidazolium bis(fluorosulfonyl)imide (EmimFSI) as a second compound. Comparative example 1 was prepared by mixing LiFSI as a lithium salt and a solvent comprising 1,2-difluorobenzene (dFBn) as an aromatic compound containing only fluorine substitute, EmimFSI as a second compound.

The ionic conductivity of the electrolyte was calculated based on the bulk resistance obtained by electrochemical impedance spectroscopy (EIS) measurements at 25° C. As shown in Table 2, electrolytes comprising CFBn showed a high conductivity and high CE, which are crucial for fast charge and long cycle life of Li metal battery.

As shown in Table 2, the electrolyte of examples 1 through 3 exhibited an ionic conductivity of 6.67 mS/cm, 8.73 mS/cm, and 10.91 mS/cm, respectively. The ionic conductivity was comparable or better than that of the comparative example 1. A lithium metal battery comprising the electrolytes of examples 1 to 3 exhibited an improved average coulombic efficiency (CE) of 99.53%, 99.35% and 99.43%, respectively. In contrast, a lithium metal battery comprising the comparative example 1 exhibited an average coulombic efficiency (CE) of 99.34%, which is lower than the examples 1-3. The increased CE indicates an improved electrochemical stability. Because the average CE is already above 99%, a small change in CE will show huge differences in cycle life.

TABLE 2
Electrolytes and their performance according
to some embodiments of the present disclosure

| | Ionic Conductivity | Initial | Average |
|---|---|---|---|
| Electrolyte^{a} | (mS/cm) | CE^{b}, % | CE^{c}, % |
| Comparative | 9.87 | 97.28 ± 0.54 | 99.34 ± 0.06 |
| example 1 | | | |
| Example 1 | 6.67 | 96.06 ± 0.41 | 99.53 ± 0.03 |
| Example 2 | 8.73 | 97.37 ± 0.35 | 99.35 ± 0.05 |
| Example 3 | 10.91 | 97.48 ± 0.22 | 99.43 ± 0.04 |

^{a}Comparative example 1 comprises 18.8 wt % LiFSI, 22.8 wt % dFBn, and 58.4 wt % EmimFSI.
Example 1 comprises 33.7 wt % LiFSI, 10.0 wt % CFBn and 56.3 wt % EmimFSI.
Example 2 comprises 30.0 wt % LiFSI, 20.0 wt % CFBn and 50.0 wt % EmimFSI.
Example 3 comprises 26.2 wt % LiFSI, 10.0 wt % CFBn and 63.8 wt % EmimFSI.
^{b}Initial CE is initial Li stripping capacity divided by initial Li plating capacity.
^{c}Average CE is total Li stripping cycle capacity divided by total Li plating cycle capacity using current density of 1.7 mA/cm² and capacity of 3.4 mAh/cm² [B. D. Adams, et al., Adv. Energy Mater., 2018, 8, 1702097].

The flammability was tested by following the method described in S. Hess et al, J. Electrochem. Soc., 2015, 162, A3084. The electrolyte was exposed to flame from a gas burner, the time for the electrolyte to be ignited by the burner was measured as Time to Ignition. Time to Self-extinguish was measured by the time between the removal of the burner and the complete extinction of the flame. Table 3 summarizes the flammability of example 1 and comparative example 1. It shows that example 1 took a longer time to ignite and was self-extinguished immediately. Both results indicate an improved thermal stability, flame resistance and safety. It was unexpected that electrolyte example 1 containing CFBn exhibited a significantly improved flame resistance with a time to ignition of 2.25 seconds, much longer than the comparative example 1, which was immediately ignited. After both electrolytes were exposed to a flame, the electrolyte of example 1 was unexpectedly and immediately self-extinguished while the electrolyte of comparative example 1 took 3.38 seconds to self-extinguish.

TABLE 3
Flammability of electrolytes according to
some embodiments of the present disclosure

| | Time to | Time to |
|---|---|---|
| Electrolyte | Ignition (s) | Self-extinguish (s) |
| Comparative example 1 | immediate | 3.38 |
| Example 1 | 2.25 | immediate |

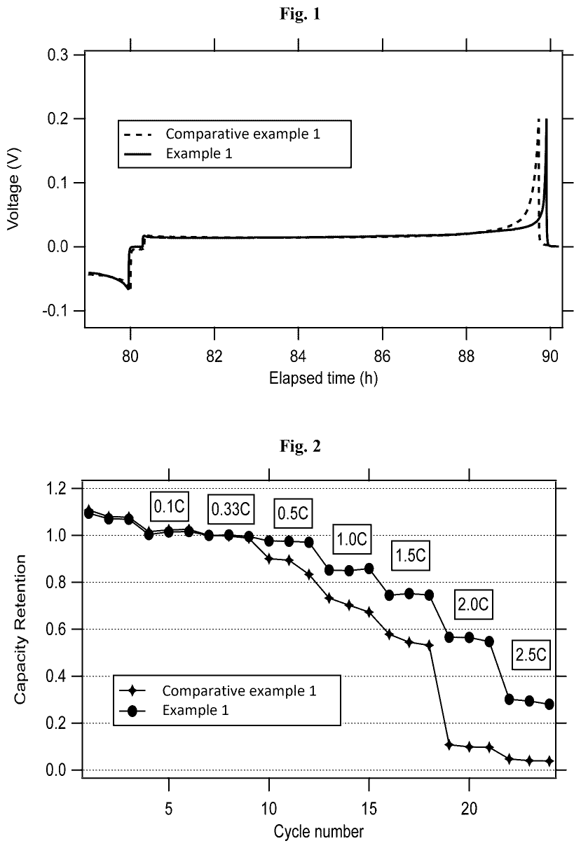

FIG. 1 shows the cycling performance of Li/Cu coin cell comprising Li metal as anode, microporous membrane as separator, Cu foil as cathode, and an electrolyte of Example 1 and comparative example 1. The thickness of Li metal is 50 m. The current density and capacity used for the Li/Cu cycling were 1.7 mA/cm² and 3.4 mAh/cm², respectively. Only the last cycle was shown for better comparison. As shown in FIG. 1, the coin cell comprising the electrolyte of example 1 exhibited a longer Li stripping time in the last plating/stripping cycle, indicating higher average CE.

FIG. 2 shows the specific capacities at various charge rates (up to 7.5 mA/cm²) of a coin cell comprising Li metal as anode, NMC811 composite electrode as cathode, microporous membrane as separator, and an electrolyte of Example 1 and comparative example 1. As shown in FIG. 2, the coin cell comprising comparative example 1 can only deliver about 10% capacity retention at 2.0 C charge rate (6.0 mA/cm²) and about 5% capacity retention at 2.5 C charge rate (7.5 mA/cm²). Capacity retention is the % of capacity the cell can deliver compared to the capacity at 0.33 C charge and 0.33 C discharge. Coin cell comprising the example 1 can deliver about 60% capacity retention at 2.0 C charge (6.0 mA/cm²) and about 30% capacity retention at 2.5 C charge (7.5 mA/cm²). Example 1 has much better rate capability than comparative example 1.

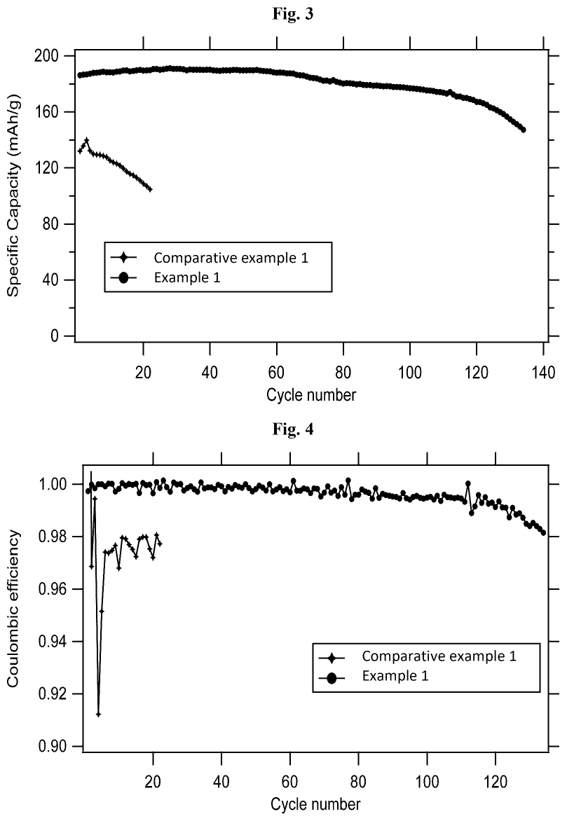

A pouch cell comprising Li metal as anode, microporous membrane as separator, Cu foil as cathode, and an electrolyte of Example 1 was assembled and the cycling performance was tested until the capacity retention rate reaches 80% of the initial capacity. The charge/discharge rates were 0.33 C. Another pouch cell was similarly assembled and tested except that the comparative example 1 was used as electrolyte. FIGS. 3 and 4 show the specific capacity and coulombic efficiency (CE) during the cycling test, respectively. It can be seen that the electrolyte 1 showed a higher specific capacity, higher CE, and a longer cycle life under the same conditions.

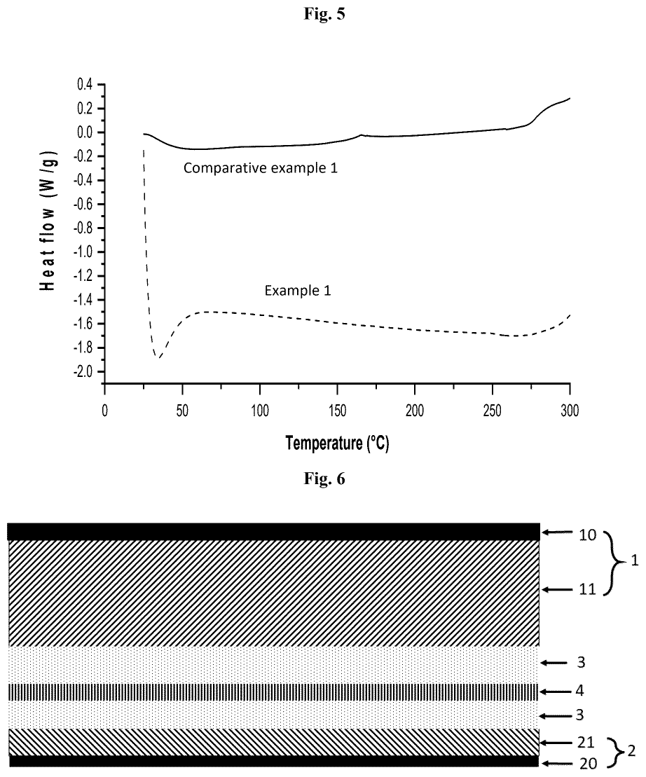

A differential scanning calorimetry (DSC) analysis was also conducted by scanning from 25 to 300° C. at a rate of 5° C./min in an atmosphere of Argon. The DSC curve of comparative example 1 and example 1 is shown in FIG. 5. The comparative example 1 exhibited two peaks around 170° C. and 280° C. while the example 1 exhibited only one tiny peak around 250° C. The DSC result also suggests an improved thermal stability.

In some embodiments, after exposure to flame, the electrolyte as disclosed herein takes at least 1 or at least 2 seconds to ignite. In some embodiments, after exposure to flame for a period of time and removal of the flame from the nonaqueous electrolyte, the nonaqueous electrolyte as disclosed herein takes less than 2 seconds or less than 1 second to self-extinguish.

### Aspects

In a first aspect, the present disclosure provides a nonaqueous electrolyte comprising:
a) an electrolyte salt; and
b) a solvent comprising an aromatic compound,
wherein the aromatic compound comprises an aromatic ring and a substitute of a non-fluorine halogen, and
wherein the aromatic compound has a boiling point of at least 110° C.

In a second aspect according to the first aspect, the aromatic compound further comprises a fluorine substitute.

In a third aspect according to the first or second aspect, the aromatic ring is an aryl or heteroaryl ring.

In a fourth aspect according to any preceding aspect, the non-fluorine halogen is at least one selected from the group consisting of Cl, Br, I, and CN.

In a fifth aspect according to any preceding aspect, the nonaqueous electrolyte has a flame-resistance better than an identical electrolyte with an aromatic compound exclusively containing fluorine as substitute.

In a sixth aspect according to any preceding aspect, the nonaqueous electrolyte takes at least 1 second to ignite by an open flame.

In a seventh aspect according to any preceding aspect, the nonaqueous electrolyte takes less than 2 seconds to self-extinguish after exposure to a flame for a period of time and removal of the flame.

In an eighth aspect according to any preceding aspect, the aromatic compound comprises at least one selected from the group consisting of chlorobenzene, 1-chloro-2-fluorobenzene, 1-chloro-3-fluorobenzene, 1-chloro-4-fluorobenzene, 1-chloro-2,4-difluorobenzene, bromobenzene, 1-bromo-2-fluorobenzene, 1-bromo-3-fluorobenzene, 1-bromo-4-fluorobenzene, 1-bromo-2,4-difluorobenzene, iodobenzene, 1-iodo-2-fluorobenzene, 1-iodo-3-fluorobenzene, 1-iodo-4-fluorobenzene, 1-iodo-2,4-difluorobenzene, and mixtures thereof.

In a ninth aspect according to any preceding aspect, the aromatic compound has a weight percentage in a range from 5 wt % to 75 wt % in the nonaqueous electrolyte.

In a tenth aspect according to any preceding aspect, the solvent further comprises a second compound miscible with the aromatic compound.

In an eleventh aspect according to the tenth aspect, the second compound comprises at least one selected from the group consisting of non-fluorinated ether, fluorinated ether, ionic liquid, ester, phosphate, and sulfone.

In a twelfth aspect according to the eleventh aspect, the ionic liquid has a weight percentage in a range from 5 wt % to 70 wt % in the nonaqueous electrolyte.

In a thirteenth aspect according to the eleventh aspect, the solvent has a boiling point of at least 110° C. at 1 atm.

In a fourteenth aspect according to the eleventh aspect, the ionic liquid is an imidazolium-based ionic liquid with a formula of

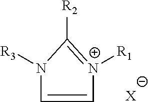

wherein R₁, R₂, R₃ are independently selected from the group consisting of hydrogen, C₁₋₁₈ alkyl, C₁₋₁₈ haloalkyl, C₁₋₁₈ hydroxyalkyl, C₁₋₁₈ aminoalkyl, C₂₋₁₈ alkenyl, C₂₋₁₈ alkynyl, and C₆₋₁₈ aryl, and X⁻ is an anion selected from the group consisting of bis(fluorosulfonyl)imide (FSI⁻), bis(trifluoromethanesulfonyl)imide (TFSI⁻), hexafluorophosphate (PF₆⁻), tetrafluoroborate (BF₄⁻), bis(oxalate)borate (BOB⁻), difluoro(oxalato)borate (DFOB⁻), trifluoromethanesulfonate (TfO⁻), nitrate (NO₃⁻), dicyanamide (DCA⁻), fluoride (F⁻), chloride (Cl⁻), bromide (Br⁻), and mixtures thereof. In some embodiments, the ionic liquid is selected from the group consisting of 1-ethyl-3-methylimidazolium bis(fluorosulfonyl) imide (EmimFSI), 1-butyl-3-methylimidazolium bis(fluorosulfonyl) imide (BmimFSI), 1-hexyl-3-methylimidazolium bis(fluorosulfonyl) imide (HmimFSI), 1-vinyl-3-methylimidazolium bis(fluorosulfonyl) imide (VmimFSI), 1-ethyl-3-methylimidazolium bis(trifluoromethanesulfonyl) imide (EmimTFSI), 1-butyl-3-methylimidazolium bis(trifluoromethanesulfonyl) imide (BmimTFSI), 1-hexyl-3-methylimidazolium bis(trifluoromethanesulfonyl) imide (HmimTFSI), 1-vinyl-3-methylimidazolium bis(trifluoromethanesulfonyl) imide (VmimTFSI) and mixtures thereof.

In a fifteenth aspect according to the eleventh aspect, the ionic liquid is a cyclic quaternary ammonium ionic liquid with a formula of

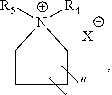

wherein R₄ and R₅ are independently selected from the group consisting of C₁₋₁₈ alkyl, C₁₋₁₈ haloalkyl, C₁₋₁₈ hydroxyalkyl, C₁₋₁₈ aminoalkyl, C₂₋₁₈ alkenyl, C₂₋₁₈ alkynyl, and C₆₋₁₈ aryl, n is an integer having a value in a range from 0 to 6, and X⁻ is an anion, selected from the group consisting of bis(fluorosulfonyl)imide (FSI⁻), bis(trifluoromethanesulfonyl)imide (TFSI⁻), hexafluorophosphate (PF₆⁻), tetrafluoroborate (BF₄⁻), bis(oxalate)borate (BOB⁻), difluoro(oxalato)borate (DFOB⁻), trifluoromethanesulfonate (TfO⁻), nitrate (NO₃⁻), dicyanamide (DCA⁻), fluoride (F⁻), chloride (Cl⁻), bromide (Br), and mixtures thereof. In some embodiments, the ionic liquid is selected from the group consisting of N-propyl-N-methylpyrrolidinium bis(fluorosulfonyl)imide (PYR13FSI), N-propyl-N-methylpyrrolidinium bis(trifluoromethanesulfonyl)imide (PYR13TFSI) 1-butyl-1-methylpyrrolidinium bis(fluorosulfonyl)imide (PYR14FSI), 1-butyl-1-methylpyrrolidinium bis(oxalate)borate (PYR14BOB), 1-butyl-1-methylpyrrolidinium bis(trifluoromethanesulfonyl)imide (PYR14TFSI), 1-butyl-1-methylpyrrolidinium dicyanamide (PYR14DCA), 1-butyl-1-methylpyrrolidinium trifluoromethanesulfonate (PYR14TfO), 1-methyl-1-(2-methoxyethyl)pyrrolidinium bis(fluorosulfonyl)imide (PYOFSI), 1-methyl-1-pentylpyrrolidinium bis(trifluoromethanesulfonyl)imide (PYR15TFSI), 1-methyl-1-octylpyrrolidinium bis(trifluoromethanesulfonyl)imide (PYR18TFSI), N-propyl-N-methylpiperidinium bis(fluorosulfonyl)imide, N-propyl-N-methylpiperidinium bis(trifluoromethanesulfonyl)imide, 1-butyl-1-methylpiperidinium bis(fluorosulfonyl)imide, 1-butyl-1-methylpiperidinium bis(oxalate)borate, 1-butyl-1-methylpiperidinium bis(trifluoromethanesulfonyl)imide, 1-butyl-1-methylpiperidinium dicyanamide, 1-butyl-1-methylpiperidinium trifluoromethanesulfonate, 1-methyl-1-(2-methoxyethyl)piperidinium bis(fluorosulfonyl)imide, 1-methyl-1-pentylpiperidinium bis(trifluoromethanesulfonyl)imide, 1-methyl-1-octylpiperidinium bis(trifluoromethanesulfonyl)imide, N-propyl-N-methylazepanium bis(fluorosulfonyl)imide, N-propyl-N-methylazepanium bis(trifluoromethanesulfonyl)imide, 1-butyl-1-methylazepanium bis(fluorosulfonyl)imide, 1-butyl-1-methylazepanium bis(oxalate)borate, 1-butyl-1-methylazepanium bis(trifluoromethanesulfonyl)imide, 1-butyl-1-methyl azepanium dicyanamide, 1-butyl-1-methylazepanium trifluoromethanesulfonate, 1-methyl-1-(2-methoxyethyl)azepanium bis(fluorosulfonyl)imide, 1-methyl-1-pentylazepanium bis(trifluoromethanesulfonyl)imide, 1-methyl-1-octylazepanium bis(trifluoromethanesulfonyl)imide and mixtures thereof.

In a sixteenth aspect according to any preceding aspect, the electrolyte salt is selected from the group consisting of lithium bis(fluorosulfonyl) imide (LiFSI), lithium perchlorate (LiClO₄), lithium hexafluorophosphate (LiPF₆), lithium borofluoride (LiBF₄), lithium hexafluoroarsenide (LiAsF₆), lithium trifluoromethanesulfonate (LiCF₃SO₃), lithium bis(trifluoromethanesulfonyl)imide (LiN(CF₃SO₂)₂, LiTFSI), lithium bis(oxalato)borate (LiBOB), lithium nitrate (LiNO₃), lithium fluoroalkylphosphates (Li[PFₓ(C_{y}F_{2y+1-z}H_{z})₆₋ₓ]) (1≤x≤5, 1≤y≤8, and 0≤z≤2y−1), lithium bis(perfluoroethanesulfonyl)imide (LiBETI), lithium difluoro(oxalato)borate (LiDFOB), lithium fluorophosphate (Li₂PO₃F), lithium difluoro(bisoxalato)phosphate (LiC₄PO₈F₂), lithium tetrafluoro oxalato phosphate (LiC₂PO₄F₄), lithium difluorophosphate (LiDFP), LiC(CF₃SO₂)₃, lithium acetate, lithium trifluoromethyl acetate, lithium oxalate, and mixtures thereof, and the electrolyte salt has a weight percentage in a range from 10 wt % to 50 wt % in the nonaqueous electrolyte.

In a seventeenth aspect according to any preceding aspect, the nonaqueous electrolyte of claim 1, further comprising a polymer with a weight percentage in a range from 0.02 wt % to 40 wt % in the nonaqueous electrolyte, wherein the polymer is in situ polymerized after mixing a monomer with the electrolyte salt and the solvent comprising the aromatic compound.

In an eighteenth aspect according to any preceding aspect, the nonaqueous electrolyte does not exhibit any exothermic or endothermic peak in a differential scanning calorimetry (DSC) curve from 25° C. to 120° C.

In a nineteenth aspect, the present disclosure provides an electrochemical device comprising the nonaqueous electrolyte according to any preceding aspect.

In a twentieth aspect according to the nineteenth aspect, the electrochemical device exhibits an average Coulombic efficiency of at least 98.0%.

Various embodiments of the features of this disclosure are described herein. However, it should be understood that such embodiments are provided merely by way of example, and numerous variations, changes, and substitutions can occur to those skilled in the art without departing from the scope of this disclosure. It should also be understood that various alternatives to the specific embodiments described herein are also within the scope of this disclosure.

We claim:

1. A nonaqueous electrolyte comprising:
a) an electrolyte salt; and
b) a solvent comprising an aromatic compound,
wherein the aromatic compound comprises an aromatic ring and a substitute of a non-fluorine halogen, and
wherein the aromatic compound has a boiling point of at least 110° C.

2. The nonaqueous electrolyte of claim 1, wherein the aromatic compound further comprises a fluorine substitute.

3. The nonaqueous electrolyte of claim 1, wherein the aromatic ring is an aryl or heteroaryl ring.

4. The nonaqueous electrolyte of claim 1, wherein the non-fluorine halogen is at least one selected from the group consisting of Cl, Br, I, and CN.

5. The nonaqueous electrolyte of claim 1, wherein the nonaqueous electrolyte has a flame-resistance better than an identical electrolyte with an aromatic compound exclusively containing fluorine as substitute.

6. The nonaqueous electrolyte of claim 1, wherein the nonaqueous electrolyte takes at least 1 second to ignite by an open flame.

7. The nonaqueous electrolyte of claim 1, wherein the nonaqueous electrolyte takes less than 2 seconds to self-extinguish after exposure to a flame for a period of time and removal of the flame.

8. The nonaqueous electrolyte of claim 1, wherein the aromatic compound comprises at least one selected from the group consisting of chlorobenzene, 1-chloro-2-fluorobenzene, 1-chloro-3-fluorobenzene, 1-chloro-4-fluorobenzene, 1-chloro-2,4-difluorobenzene, bromobenzene, 1-bromo-2-fluorobenzene, 1-bromo-3-fluorobenzene, 1-bromo-4-fluorobenzene, 1-bromo-2,4-difluorobenzene, iodobenzene, 1-iodo-2-fluorobenzene, 1-iodo-3-fluorobenzene, 1-iodo-4-fluorobenzene, 1-iodo-2,4-difluorobenzene, and mixtures thereof.

9. The nonaqueous electrolyte of claim 1, wherein the aromatic compound has a weight percentage in a range from 5 wt % to 75 wt % in the nonaqueous electrolyte.

10. The nonaqueous electrolyte of claim 1, wherein the solvent further comprises a second compound miscible with the aromatic compound.

11. The nonaqueous electrolyte of claim 10, wherein the second compound comprises at least one selected from the group consisting of non-fluorinated ether, fluorinated ether, ionic liquid, ester, phosphate, and sulfone.

12. The nonaqueous electrolyte of claim 11, wherein the ionic liquid has a weight percentage in a range from 5 wt % to 70 wt % in the nonaqueous electrolyte.

13. The nonaqueous electrolyte of claim 11, wherein the solvent has a boiling point of at least 110° C. at 1 atm.

14. The nonaqueous electrolyte of claim 11, wherein the ionic liquid is an imidazolium-based ionic liquid with a formula of 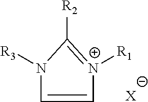
wherein R₁, R₂, R₃ are independently selected from the group consisting of hydrogen, C₁₋₁₈ alkyl, C₁₋₁₈ haloalkyl, C₁₋₁₈ hydroxyalkyl, C₁₋₁₈ aminoalkyl, C₂₋₁₈ alkenyl, C₂₋₁₈ alkynyl, and C₆₋₁₈ aryl, and X⁻ is an anion selected from the group consisting of bis(fluorosulfonyl)imide (FSI⁻), bis(trifluoromethanesulfonyl)imide (TFSI⁻), hexafluorophosphate (PF₆⁻), tetrafluoroborate (BF₄), bis(oxalate)borate (BOB⁻), difluoro(oxalato)borate (DFOB⁻), trifluoromethanesulfonate (TfO⁻), nitrate (NO₃⁻), dicyanamide (DCA⁻), fluoride (F⁻), chloride (Cl⁻), bromide (Br⁻), and mixtures thereof.

15. The nonaqueous electrolyte of claim 11, wherein the ionic liquid is a cyclic quaternary ammonium ionic liquid with a formula of 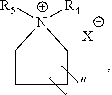
wherein R₄ and R₅ are independently selected from the group consisting of C₁₋₁₈ alkyl, C₁₋₁₈ haloalkyl, C₁₋₁₈ hydroxyalkyl, C₁₋₁₈ aminoalkyl, C₂₋₁₈ alkenyl, C₂₋₁₈ alkynyl, and C₆₋₁₈ aryl, n is an integer having a value in a range from 0 to 6, and X⁻ is an anion, selected from the group consisting of bis(fluorosulfonyl)imide (FSI⁻), bis(trifluoromethanesulfonyl)imide (TFSI⁻), hexafluorophosphate (PF₆⁻), tetrafluoroborate (BF₄⁻), bis(oxalate)borate (BOB⁻), difluoro(oxalato)borate (DFOB⁻), trifluoromethanesulfonate (TfO⁻), nitrate (NO₃⁻), dicyanamide (DCA⁻), fluoride (F⁻), chloride (Cl⁻), bromide (Br⁻), and mixtures thereof.

16. The nonaqueous electrolyte of claim 1, wherein the electrolyte salt is selected from the group consisting of lithium bis(fluorosulfonyl) imide (LiFSI), lithium perchlorate (LiClO₄), lithium hexafluorophosphate (LiPF₆), lithium borofluoride (LiBF₄), lithium hexafluoroarsenide (LiAsF₆), lithium trifluoromethanesulfonate (LiCF₃SO₃), lithium bis(trifluoromethanesulfonyl)imide (LiN(CF₃SO₂)₂, LiTFSI), lithium bis(oxalato)borate (LiBOB), lithium nitrate (LiNO₃), lithium fluoroalkylphosphates (Li[PFₓ(C_{y}F_{2y+1-z}H_{z})₆₋ₓ]) (1≤x≤5, 1≤y≤8, and 0≤z≤2y−1), lithium bis(perfluoroethanesulfonyl)imide (LiBETI), lithium difluoro(oxalato)borate (LiDFOB), lithium fluorophosphate (Li₂PO₃F), lithium difluoro(bisoxalato)phosphate (LiC₄PO₈F₂), lithium tetrafluoro oxalato phosphate (LiC₂PO₄F₄), lithium difluorophosphate (LiDFP), LiC(CF₃SO₂)₃, lithium acetate, lithium trifluoromethyl acetate, lithium oxalate, and mixtures thereof, and the electrolyte salt has a weight percentage in a range from 10 wt % to 50 wt % in the nonaqueous electrolyte.

17. The nonaqueous electrolyte of claim 1, further comprising a polymer with a weight percentage in a range from 0.02 wt % to 40 wt % in the nonaqueous electrolyte, wherein the polymer is in situ polymerized after mixing a monomer with the electrolyte salt and the solvent comprising the aromatic compound.

18. The nonaqueous electrolyte of claim 17, wherein the nonaqueous electrolyte does not exhibit any exothermic or endothermic peak in a differential scanning calorimetry (DSC) curve from 25° C. to 120° C.

19. An electrochemical device comprising the nonaqueous electrolyte of claim 1.

20. The electrochemical device of claim 19, wherein the electrochemical device exhibits an average Coulombic efficiency of at least 98.0%.
